(19) United States
(12) Patent Application Publication
(10) Pub. No.: US 2004/0086654 A1
(43) Pub. Date: May 6, 2004

(54) Method for making micro drill using exposure liquid

(76) Inventor: Seong-Koo Lee, Jeongri-dong (KR)

Correspondence Address: HOWREY LLP, ATTORNEYS AT LAW, 750 Bering Drive, Houston, TX, 77057-2198, US

(21) Appl. No.: 10/222,548

(22) Filed: Aug. 16, 2002

(51) Int. Cl. B05D 1/18

(52) U.S. Cl. 427/430.1

(57) ABSTRACT

A method of making a micro drill using exposure liquid includes an exposure liquid coating process of putting a micro drill having a processed drill bit into exposure liquid so as to dip the processed drill bit in the exposure liquid; a twist groove exposure process of processing a twist groove on an exposure liquid coating surface by scanning a laser beam from a laser exposure machine while the drill bit of the micro drill, coated by the exposure liquid, advances with rotating; a twist groove etching process of putting the coated surface of the micro drill into etching solution so as to resolve metal at the twist groove in which the exposure liquid coating film is removed by exposure of the laser beam; and a drill coating washing process of washing the drill coating by putting the etched drill bit into an ultrasonic washer.

### TECHNICAL FIELD

The present invention relates to processing a twist groove of a micro-grade drill by using exposure liquid, and more particularly to method and apparatus for making a micro drill using exposure liquid, which makes the micro drill by processing a diameter of a drill bit, then coating the exposure liquid on the drill bit, simply shaping a twist groove by using a laser exposure machine, and then etching the twist groove.

### BACKGROUND ART

A drill processing is one of basic processing methods in the mechanical processing techniques, which is on a trend of gradually increasing speed in aspect of productivity improvement. Recently, to keep up with intelligent functions, diversification, miniaturization, etc. of electronic products, minuteness of the drill processing is also required.

Such drill processing is recently performed in a micro grade owing to high-technological medical instruments or development of new materials using small-sized elements, and therefore it is urgent to develop a new drill of a micro grade for processing these elements and evaluate its processing ability for these new materials.

Such a micro-grade drill, like a processing procedure shown in FIG. Such a micro-grade drill, like a processing procedure shown in FIG. 1, processes a micro drill bit (SK, SKS, HSS, carbide) through \overline{} process—grinding of a centerless portion using a diamond wheel, α process—grinding of a side using a diamond wheel, β process—first grinding of a point for shaping a drill bit, χ process—tapering of the drill bit and grinding of a bit diameter, δ process—first processing of a drill groove, ε process—second processing of the drill groove, φ process—processing of the drill bit, γ process—grinding of the taper and the bit diameter, η process—grinding of a point angle, and ι process—inspection and processing of a finished product.

Among the above processes, the drill groove (twist groove) processing is most sophisticated, and has a very minute diameter of 100 μm˜30 μm. Therefore, in the mass production, it is difficult to process the groove less than a diameter of 80 μm in the mechanical processing because of limitations such as defective proportion, process ability, productivity and diamond wheel problem used for the processing.

Now, it is known that some countries possessing the micro drill manufacturing techniques can make the micro drill up to a diameter of 50 μm, but not yet come into the market.

### DISCLOSURE OF INVENTION

The present invention has an object to realize the mass production with high minuteness and without defectives in a twist groove processing, which is a high-technological miniature processing technique.

The present invention enables an etched portion to be processed in predetermined depth and width and along a predetermined twist angle by dipping the drill bit in exposure liquid.

The present invention therefore provides a method of making a micro drill using exposure liquid, which includes an exposure liquid coating process of putting a micro drill having a processed drill bit into exposure liquid so as to dip the processed drill bit in the exposure liquid; a twist groove exposure process of processing a twist groove on an exposure liquid coating surface by scanning a laser beam from a laser exposure machine while the drill bit of the micro drill, coated by the exposure liquid, advances with rotating; a twist groove etching process of putting the coated surface of the micro drill into etching solution so as to resolve metal at the twist groove in which the exposure liquid coating film is removed by exposure of the laser beam; and a drill coating washing process of washing the drill coating by putting the etched drill bit into an ultrasonic washer.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 shows a conventional procedure of processing a micro drill;

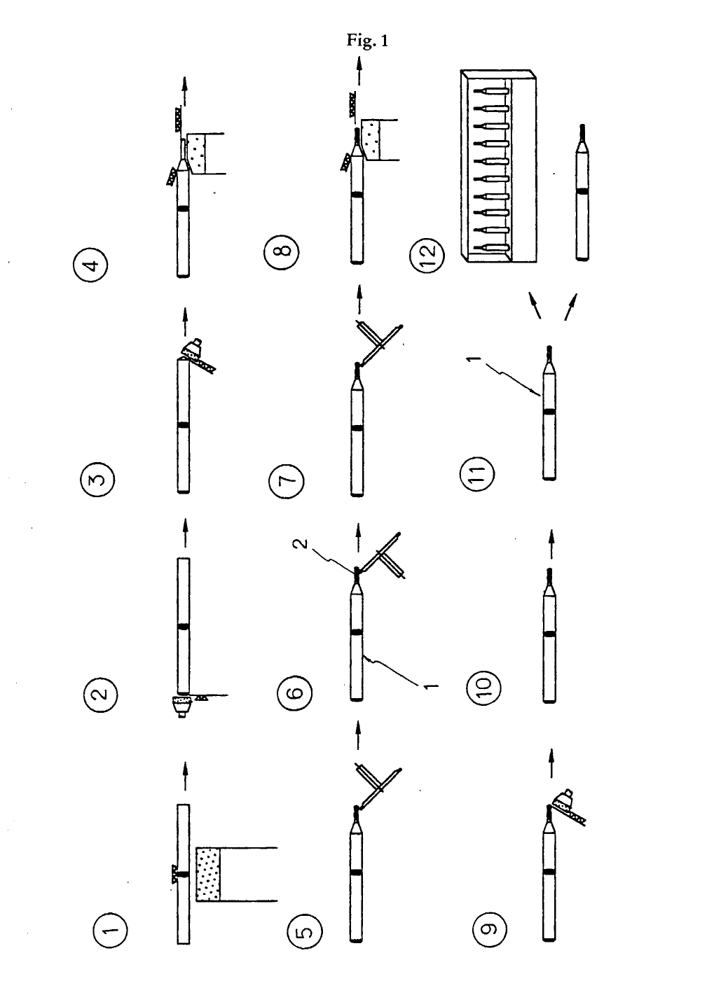

FIG. 2 shows a procedure of processing a micro drill according to the present invention;

FIG. 3 shows a process of coating exposure liquid on a processed drill bit of the present invention;

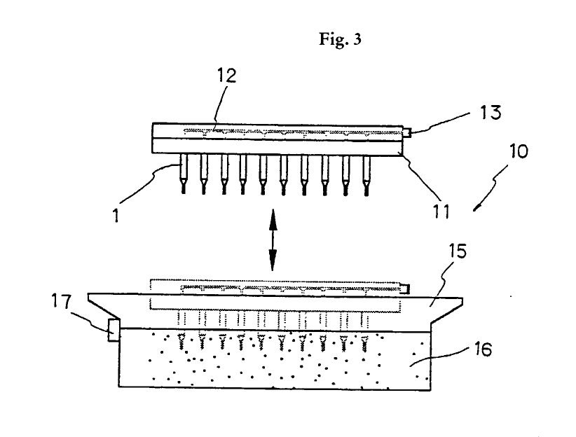

FIG. 4 shows a process of exposing a twist groove on the drill bit of the present invention;

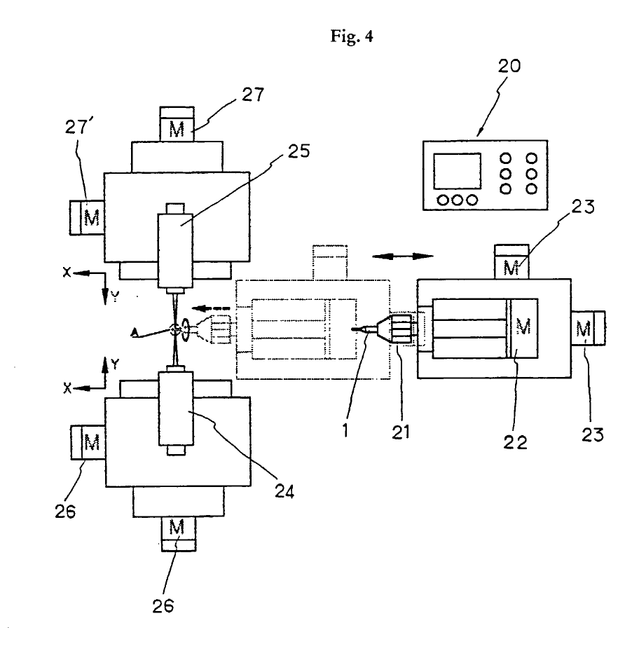

FIG. 5 shows a process of etching the twist groove on the drill bit of the present invention;

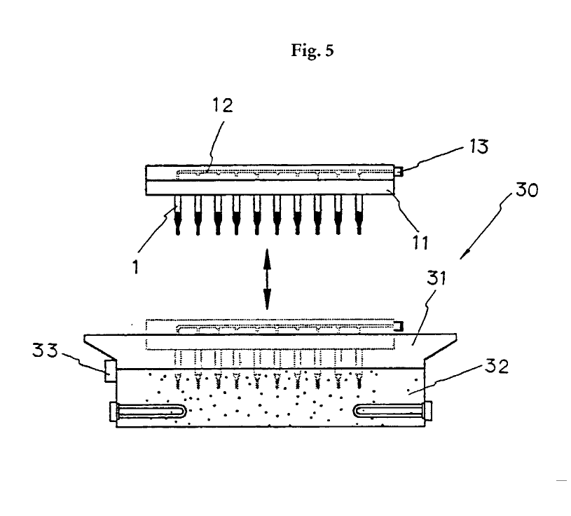

FIG. 6 shows a process of washing the drill bit of the present invention; and

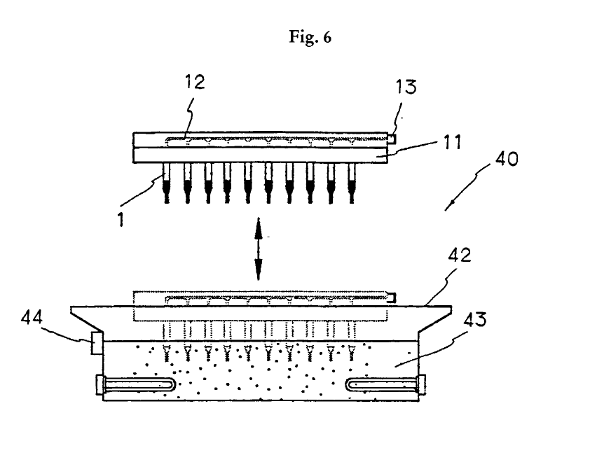

FIG. 7 shows a processing state of the micro drill according to the present invention.

### BEST MODES FOR CARRYING OUT THE INVENTION

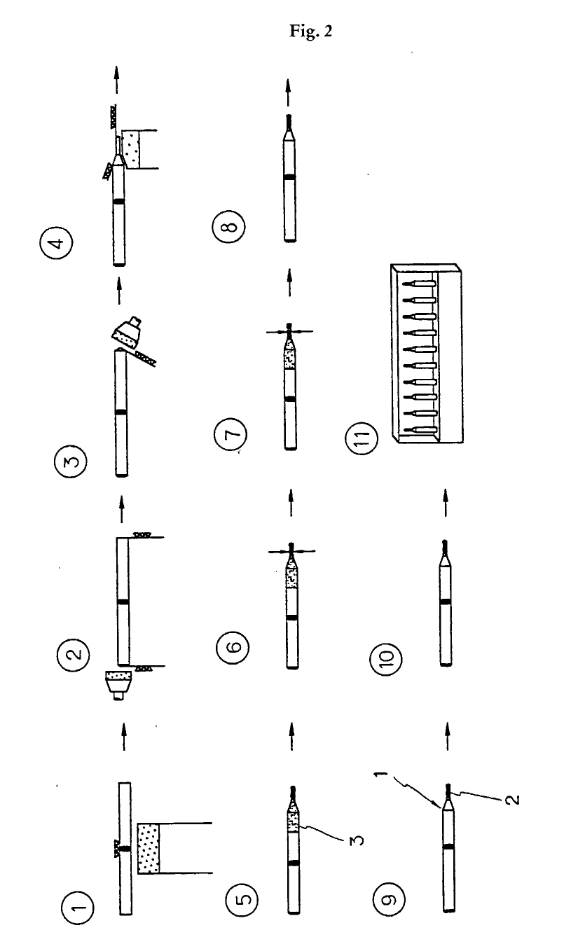

Hereinafter, preferred embodiments of the present invention will be described in detail with reference to the accompanying drawings. A micro drill 1 of the present invention is shaped according to the procedure shown in FIG. 2, and clearly described through embodiments below.

### First Embodiment

A drill having a diameter of 100 μm˜30 μm

### (1) Contour Processing

After preparing a material and fixing the material to a machine tool or a special purpose machine to have a shank of a certain length, a centerless grinding is performed with using a diamond wheel.

### (2) Side Processing

A side grinding is performed for both sides of the material having a processed appearance by using the diamond wheel.

### (3) Point Angle Processing

A point angle is grinded at a side for processing a drill bit 2 by using the diamond wheel.

### (4) Drill Bit Diameter Processing

Diameter and taper of the drill bit 2 are grinded at a side having a processed point angle by using the diamond wheel.

### (5) Exposure Liquid Coating

The micro drill 1 of which a diameter of the drill bit 2 is processed are inserted to a drill fixing jig 11, in which a plurality of insert holes 14 are formed at a regular interval, and then air may be sucked from outside through an air hose connecting unit 13 because an air hole 12 is connected to the insert hole 14.

The air is sucked from outside by using a vacuum pump blower so that the micro drill 1 may not be separated from the insert hole 14. The micro drill 1 is dipped in the exposure liquid through an exposure liquid coating process, which includes descending the drill fixing jig 11, then sufficiently dipping (coating) the drill bit 2 of the micro drill 1 to be soaked, and then taking out the micro drill 1 so that the exposure liquid (sensitizing solution) may be dried.

### (6) Twist Groove Exposing

After separating from the drill fixing jig 11, the micro drill 1, dipped into the exposure liquid, is fixed to a collet chuck 21 in a twist groove exposure process (20), and then moved straight to X axis by using servo motors 23, 23′ while the collet chuck 21 rotates to U axis by a servo motor 22.

In front of the collet chuck 21, servo motors 26, 26′, 27, 27′ are respectively installed to both sides of the collet chuck 21, and CNC laser exposure machines 24, 25 are installed thereto to be movable to X and Y axes in order to process the twist groove 4 according to an input program.

That is, if moving the collet chuck 21 forward and backward while scanning a laser beam (0.1˜0.5 μm) from a drill twist angle program to a surface coated by the exposure liquid according to a drill twist angle program, the laser beam removes a coating from the surface at a position corresponding to the twist groove 4 required for the drill bit 2.

At this time, preferably, width and depth of the twist groove 4 of the drill bit 2 and a drill twist angle may be adjusted, and the twist groove 4 is shaped by removing the exposure liquid coating film by exposure to the laser beam.

In addition, the twist groove is formed with a straight moving accuracy of 0.1 μm and a surface roughness of 0.1˜0.5 μm.

### (7) Twist Groove Etching

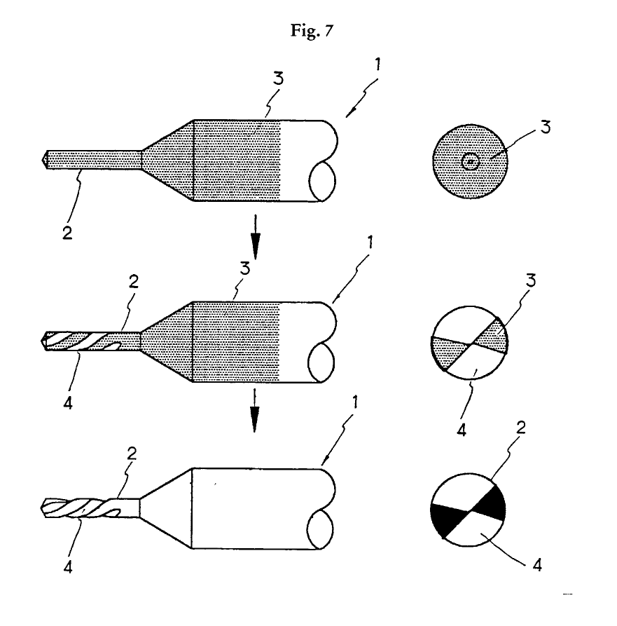

After exposing a shape of the twist groove 4 on the drill bit 2 by the laser beam through the twist groove exposure process as shown in FIG. 7, a plurality of the micro drills 1 are inserted into the insert holes 14 of the drill fixing jig 11.

If the air hose connecting unit 13 sucks air through the air hole 12 from an external vacuum pump, a fixed state of the micro drill 1 to the drill fixing jig 11 is maintained.

The drill fixing jig 11 having the micro drills 1 fixed thereto is put into a tank 31, which contains etching solution to a certain level by using a position sensor 33, for the purpose of the etching.

The micro drill 1 is put in the etching solution 32 so that up to 60% of the coated portion by the exposure liquid 16 may be sunk in the tank 31 for etching.

Then, the exposed portion (twist groove) by the laser beam acts on a chemical reaction so as to resolve (dig) the twist groove 4 of the drill bit 2.

In the twist groove etching 30, the twist groove 4 is etched to obtain an optimal processing condition.

### (8) Drill Coating Washing

After the etching, the drill fixing jig 11 fixed with the micro drills 1 with the twist groove 4 processed is put into an ultrasonic washer 41 configured with a tank 42, which contains a wash water 43 to a certain level by a position sensor 44, for the purpose of the ultrasonic washing of the exposure liquid.

### (9) Inspecting and Finishing

By inspecting an outer appearance and packaging the micro drill 1, the procedure of making the micro drill 1 is completed.

The present invention makes it possible to realize mass production with high minuteness and without defectives of the twist groove processing, which is high-technical miniature processing technique among the micro drill processing method.

The present invention may enable to etch the twist groove according to predetermined length, width and twist angle by dipping the drill bit in the exposure liquid.

The present invention may manufacture more than several ten times of micro drills, compared with the conventional grinding method, by inserting many drill bits (about more than 200) to the drill fixing jig and then etching them at once, though it takes more time than ten times of the grinding method.

What is claimed is:

1. A method of making a micro drill (1) using exposure liquid, which shapes the micro drill by means of centerless grinding, side grinding, point angle grinding and bit diameter grinding, the method comprising:
an exposure liquid coating process of putting a micro drill having a processed drill bit into exposure liquid so as to dip the processed drill bit in the exposure liquid;
a twist groove exposure process of processing a twist groove on an exposure liquid coating surface by scanning a laser beam from a laser exposure machine while the drill bit of the micro drill, coated by the exposure liquid, advances with rotating;
a twist groove etching process of putting the coated surface of the micro drill into etching solution so as to resolve metal at the twist groove in which the exposure liquid coating film is removed by exposure of the laser beam; and
a drill coating washing process of washing the drill coating by putting the etched drill bit into an ultrasonic washer.

2. An apparatus for making a micro drill (1) using exposure liquid, which shapes the micro drill by means of centerless grinding, side grinding, point angle grinding and bit diameter grinding, the apparatus being made by the following processes including:
an exposure liquid coating process (10) of fixing a micro drill (1) having a processed drill bit (2) to a drill fixing jig (11) in which at least two insert holes (14) are formed, and putting the micro drill (1) into a tank (15) containing exposure liquid (16) so as to dip the processed drill bit (2) in the exposure liquid (16);
a twist groove exposure process (20)of removing the exposure liquid at a portion of an exposure liquid coating surface (3) where a twist groove (4) is to be formed (3) by scanning a laser beam from laser exposure machines (24)(25) while the micro drill (1), coated by the exposure liquid (16) and fixed to a collet chuck (21), advances in straight with rotating by using a servo motor (22);
a twist groove etching process (30) of putting the coated surface (3) of the micro drill (1) into a tank (31) containing etching solution (32) so as to resolve metal at the twist groove (4) in which the exposure liquid coating surface (3) is removed by exposure of the laser beam; and
a drill coating washing process (40) of washing the exposure liquid coating surface (3) of the etched drill bit (2) by putting into wash water (43) of an ultrasonic washer (41).

3. The apparatus for making a micro drill (1) using exposure liquid as claimed in claim 2,
wherein the micro drills (1) are inserted to a plurality of insert holes (14) of the drill fixing jig (11) and connected to an air hose connecting unit (13) through an air hole (12) so as to be fixed to the drill fixing jig (11) by air suction of a vacuum pump.

4. The method of making a micro drill (1) using exposure liquid as claimed in 1,
wherein the laser beam (0.1˜0.5 μm) is scanned conforming to a size of the twist groove so that a shape of the twist groove is exposed on the exposure liquid coating surface.

5. The apparatus for making a micro drill (1) using exposure liquid as claimed in 2,
wherein the laser beam (0.1˜0.5 μm) is scanned conforming to a size of the twist groove so that a shape of the twist groove is exposed on the exposure liquid coating surface.
